(19) United States
(12) Patent Application Publication
(10) Pub. No.: US 2002/0034041 A1
(43) Pub. Date: Mar. 21, 2002

(54) Disc stack clamping with radially offset clamping surfaces

(76) Inventors: Erming Luo, Orefield, PA (US); Roy Lynn, Yukon, OK (US); John Daniel Stricklin, Oklahoma City, OK (US)

Correspondence Address: Shawn B. Dempster, Seagate Technology LLC, 1280 Disc Drive, SHK2LG, Shakopee, MN, 55379-1863, US

(21) Appl. No.: 09/895,966

(22) Filed: Jun. 29, 2001

Related U.S. Application Data
(60) Provisional application No. 60/233,889, filed on Sep. 20, 2000.

(51) Int. Cl. G11B 17/02

(52) U.S. Cl. 360/99.12

(57) ABSTRACT

A data disc support assembly comprising a hub with a first axial end and a second axial end and a flange depending from the second axial end, the flange comprising a contact surface extending radially from the central axis between an inner contact surface radius and an outer contact surface radius and imparting a clamping force toward one surface of the disc. A clamp connected to the hub comprises a contact surface imparting a clamping force toward an opposing surface of the disc, the clamp contact surface extending radially from the central axis between in inner contact surface radius and an outer contact surface radius, wherein the flange contact surface and the clamp contact surface are substantially equivalent and radially offset.

CROSS REFERENCE TO RELATED APPLICATIONS

This application claims the benefit of U.S. Provisional Application No. 60/233,889 filed Sep. 20, 2000.

1. Field of the Invention

This invention relates generally to the field of disc drive data storage devices, and more particularly but not by way of limitation to connecting a data disc to a motor so as to minimize coning of the data disc as a result of axial forces imparted by the connector.

2. Background of the Invention

Modem disc drives are commonly used in a multitude of computer environments to store large amounts of data in a form that is readily available to a user. Generally, a disc drive has a magnetic disc, or two or more stacked magnetic discs, that are rotated by a motor at a high speed. Each disc has a data storage surface divided into a series of generally concentric data tracks where data is stored in the form of magnetic flux transitions.

A data transfer member such as a magnetic transducer is moved by an actuator to selected positions adjacent the data storage surface to sense the magnetic flux transitions in reading data from the disc, and to transmit electrical signals to induce the magnetic flux transitions in writing data to the disc. The active elements of the data transfer member are supported by suspension structures extending from the actuator. The active elements are maintained a small distance above the data storage surface upon an air bearing generated by air currents caused by the spinning discs.

A continuing trend in the industry is toward ever-increasing data storage capacity and processing speed while maintaining or reducing the physical size of the disc drive. Consequently, the data transfer member and supporting structures are continually being miniaturized, and data storage densities are continually being increased. The result is an overall increased sensitivity of the data transfer member positioning control systems to sources of positioning error.

One such source of positioning error occurs when the disc, which is theoretically flat, becomes deformed. Discs are known to warp from deformation resulting from attachment forces applied in securing the disc to the spindle motor. It has been determined that by offsetting the application of axial clamping forces that deformation in the disc, and more particularly disc coning, can be reduced. It is to this improvement that embodiments of the present invention are directed.

### SUMMARY OF THE INVENTION

Embodiments of the present invention are directed to a data disc support assembly for supporting a data disc spinning around a central axis relative to a head disposed in a data reading and writing relationship with the disc. The data disc support assembly comprises a hub comprising first and second axial ends and a flange depending from the second axial end, the flange comprising a contact surface extending radially from the central axis between an inner contact surface radius and an outer contact surface radius and imparting a clamping force toward one surface of the disc. The data disc support assembly further comprises a clamp connected to the hub and comprising a contact surface imparting a clamping force toward an opposing surface of the disc, the clamp contact surface extending radially from the central axis between in inner contact surface radius and an outer contact surface radius, wherein the flange contact surface and the clamp contact surface are substantially equivalent and radially offset.

Other embodiments of the present invention contemplate a disc drive comprising an enclosure, a motor supported by the enclosure, and the data disc support assembly connected to the motor and spinning, in turn, a data disc in fixed rotation with the motor.

These and various other features as well as advantages which characterize the present invention will be apparent upon reading of the following detailed description and review of the associated drawings.

### BRIEF DESCRIPTION OF THE DRAWINGS

FIG. 1 is a plan view of a disc drive assembly constructed in accordance with an embodiment of the present invention.

FIG. 2 is a partial cross-sectional view of the disc clamp assembly of the disc drive assembly of FIG. 1 constructed in accordance with an embodiment of the present invention.

FIG. 3 is a diagrammatic view of a portion of a disc clamp assembly similar to FIG. 2 but having four rather than two discs.

FIG. 4 is a diagrammatic illustration of the opposing offset axial force vectors fixing the discs in rotation with the spindle motor in accordance with embodiments of the present invention.

FIGS. 5 and 6 are enlarged views of the disc clamp of the disc drive assembly of FIG. 1 illustrating arcuate and annular embodiments, respectively, of disc clamp contact surfaces.

### DETAILED DESCRIPTION

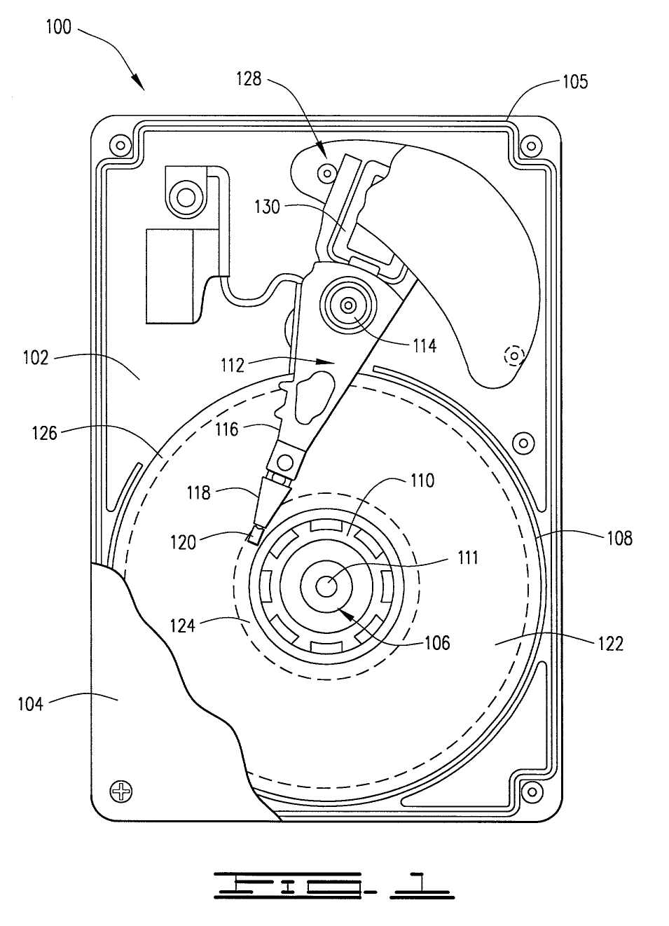

Referring to the drawings in general, and more particularly to FIG. 1 which is a plan representation of a disc drive 100 constructed in accordance with the present invention. The disc drive 100 includes a base deck 102 to which various disc drive components are mounted, and a cover 104 (partially cut-away) which together with the base deck 102 and a perimeter gasket 105 form an enclosure providing a sealed internal environment for the disc drive 100. Numerous details of construction are not included in the following description because they are well known to a skilled artisan and are unnecessary for an understanding of the present invention.

Mounted to the base deck 102 is a motor 106 to which one or more discs 108 are stacked and secured by a clamp ring 110 for rotation at a high speed around a central axis 111. Where a plurality of discs 108 are stacked to form a disc stack, adjacent discs 108 are typically separated by a disc spacer (shown below). An actuator 112 pivots around a pivot bearing 114 in a plane parallel to the discs 108. The actuator 112 has actuator arms 116 (only one shown in FIG. 1) that support load arms 118 in travel across the discs 108 as the actuator arms 116 move within the spaces between adjacent discs 108. The load arms 118 are flex members that support data transfer members, such as read/write heads 120, with each of the read/write heads 120 adjacent a surface of one of the discs 108 and maintained in a data reading and writing spatial relationship by a slider (not shown) which operably supports the read/write head 120 on an air bearing sustained by air currents generated by the spinning discs 108.

Each of the discs 108 has a data storage region comprising a data recording surface 122 divided into concentric circular data tracks (not shown). Each of the read/write heads 120 is positioned adjacent a respective desired data track to read data from or write data to the data track. The data recording surface 122 can be bounded inwardly by a circular landing zone 124 where the read/write heads 120 can come to rest against the respective discs 108 at times when the discs 108 are not spinning. The data recording surface 122 can be similarly bounded outwardly by an overshoot cushion zone 126 beyond the outermost data track.

The actuator 112 is positioned by a voice coil motor (VCM) 128 comprising an electrical coil 130 and a magnetic circuit source. The magnetic circuit source conventionally comprises one or more magnets supported by magnetic poles to complete the magnetic circuit. When controlled current is passed through the actuator coil 130, an electromagnetic field is set up which interacts with the magnetic circuit causing the actuator coil 130 to move. As the actuator coil 130 moves, the actuator 112 pivots around the pivot bearing 114, causing the read/write heads 120 to travel across the discs 108.

The discs 108 are connected in fixed rotation with the spindle motor 106 so as to spin at high speed to present the data stored in sectors lying along the annular data tracks to the read/write head 120. It is important, therefore, that the disc 108 be sufficiently clamped to the spindle motor 106 to prevent slippage therebetween. The axial clamping force can, however, adversely impart deformation such as warpage and/or coning to the disc 108, creating fly height and off-track positioning errors.

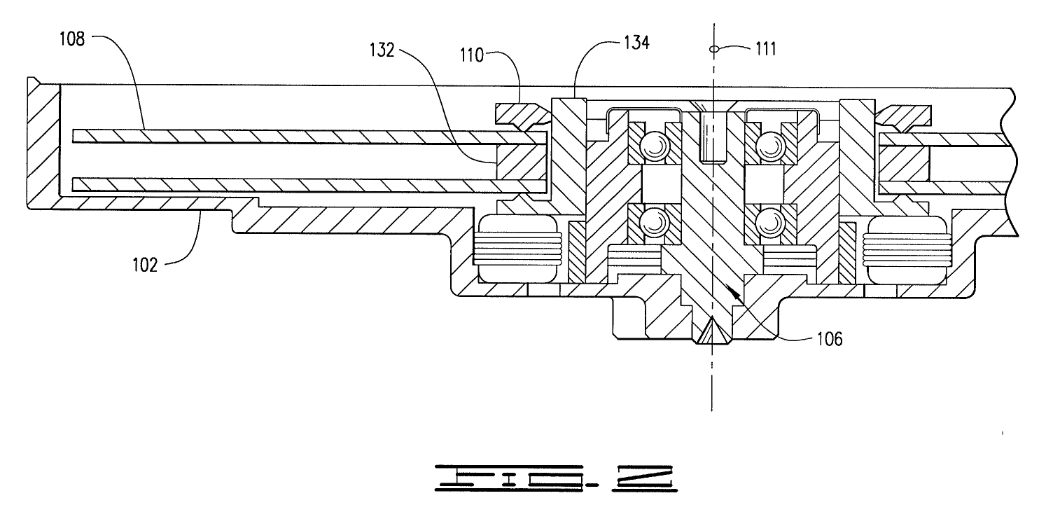

FIG. 2 is a partial cross-sectional view of a portion of the disc drive assembly 100 of FIG. 1. Although a ball bearing type spindle motor 106 is illustrated, other embodiments are contemplated as well such as the use of a hydrodynamic spindle motor and the like. Also, although a disc stack of two discs 108 with a spacer 132 fixed in rotation with a hub 134 of the spindle motor 106 is illustrated, other embodiments are contemplated as well having any desired number of discs 108, such as the enlarged view in FIG. 3 of a portion of the disc drive assembly of FIG. 2 but showing an embodiment having four discs 108 with spacers 132 interposed between adjacent discs 108.

Staying with the embodiment in FIG. 3, the discs 108 and spacers 132 are stacked on the hub 134 between a first axial end 135 and a second axial end 136. The second axial end 136 has a flange portion 137 of relatively greater diameter. Typically, the discs 108 and spacers 132 are stacked onto the flange 137 and then the clamp 110 is attached so as to grippingly engage an outer diameter surface 138 of the hub 134 at the first axial end 135. The clamp 110 also typically imparts an axial force to the disc stack which is opposed by the flange 137. Commonly, the clamp 110 is a shrink-fit type member that is heated to a predetermined temperature so that a central bore of the clamp 110 is made large enough to receivingly engage the hub 134, at which time the clamp 110 is thrust onto the hub 134 with a predetermined axial loading force.

FIG. 3 generally illustrates a clamp 110 and flange 137 arrangement in accordance with an embodiment of the present invention, wherein the clamp 110 has a contact strip 140 imparting the axial force from the clamp 110 to the disc stack and the flange 137 has a contact strip 142 supporting the disc stack in opposition to the clamp 110 axial force. Generally, it is to the size and placement of these opposing contact strips 140, 142 that embodiments of the present invention are directed.

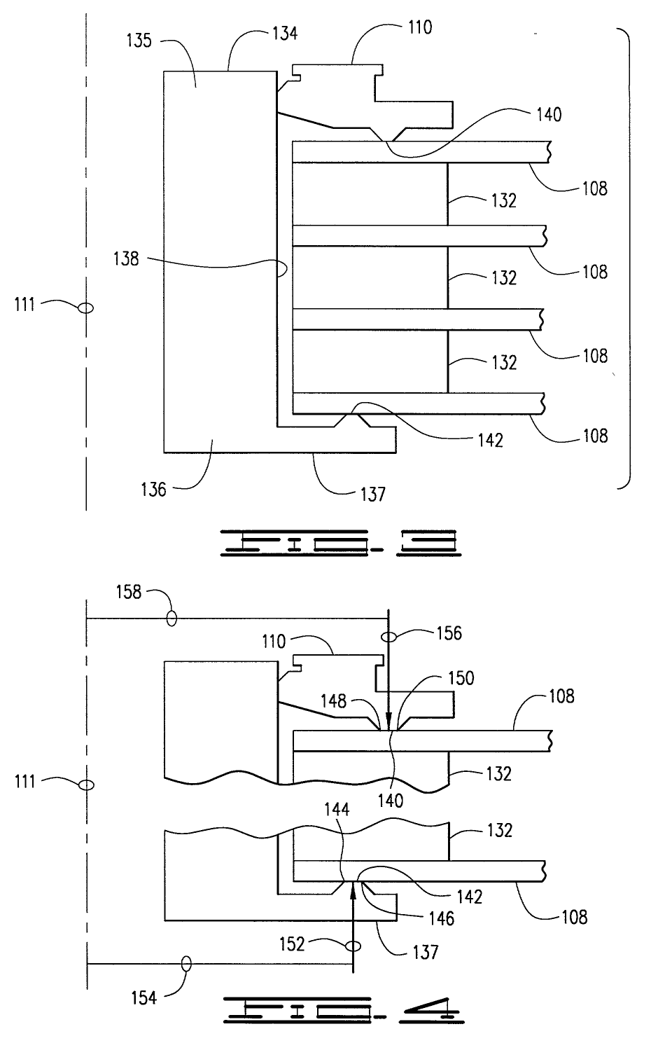

FIG. 4 is a simplified diagrammatic representation of the data disc support assembly of the disc drive of FIG. 1, representative of a disc stack with one or more discs and the associated number of spacers 132 interposed therebetween adjacent discs 108. Namely, two discs 108 and partial spacers 132 are illustrated in FIG. 4 but embodiments of the present invention also contemplate a disc stack of one disc 108 wherein the clamp 110 and the flange 137 directly pressingly engage opposing sides of the disc 108.

FIG. 4 illustrates the flange contact strip 142 comprising a contact surface extending radially from the central axis 111 between an inner contact surface radius 144 and an outer contact surface radius 146. It is along this contact surface of the contact strip 142 that the flange 137 imparts the clamping force toward one surface of the disc 108. Similarly, the clamp contact strip 140 comprises a contact surface extending radially from the central axis 111 between an inner contact surface radius 148 and an outer contact surface radius 150.

Preferably, the flange contact surface 142 and the clamp contact surface are substantially equivalent in length and are radially offset on opposing sides of the disc stack. For example, in FIG. 4 the flange 137 exerts a clamping force to the disc stack in direction indicated by reference arrow 152 (upward vector 152 in FIG. 4) passing through the midpoint of the flange contact surface 142. The vector 152 acts at a distance from the central axis 111 indicated by the reference length 154. Opposingly, the clamp 110 exerts a clamping force to the disc stack in direction indicated by reference arrow 156 (downward vector in FIG. 4) passing through the midpoint of the clamp contact surface 140. The vector 156 acts at a distance from the central axis 111 indicated by the reference length 158. The vectors 152, 156 are radially offset, thereby resulting in a vector coupling effect that substantially reduces the amount of deformation imparted to the discs 108 from the axial loading forces. Particularly, the offset forces reduce the amount of resulting coning effect imparted to the discs 108.

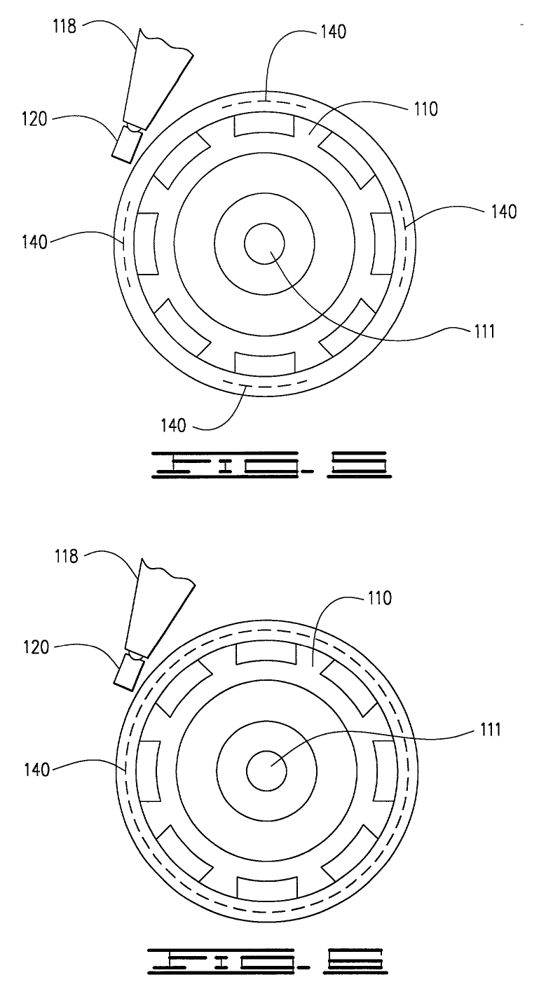

FIG. 5 is an enlarged view of the disc clamp portion of the disc drive assembly of FIG. 1, illustrating the disc clamp contact surface 140 comprising one or more arcuate surfaces acting along a substantially common radial distance from the central axis 111. The flange contact surface (not shown) can similarly comprise one or more arcuate surfaces disposed axially aligned with or staggered with the clamp contact surface or surfaces 140. FIG. 6 illustrates an alternative embodiment wherein the clamp contact surface 140 comprises an annular surface acting along a substantially common radial distance from the central axis 111.

In summary, a data disc support assembly is provided for supporting a data disc (such as 108) spinning around a central axis (such as 111) relative to a head (such as 120) disposed in a data reading and writing relationship with the disc.

The data disc support assembly comprises a hub (such as 135) comprising first and second axial ends (such as 134, 136) and a flange (such as 137) depending from the second axial end, the flange comprising a contact surface (such as 142) extending radially from the central axis between an inner contact surface radius (such as 144) and an outer contact surface radius (such as 146) and imparting a clamping force toward one surface of the disc.

The data disc support assembly further comprises a clamp (such as 110) connected to the hub and comprising a contact surface (such as 140) imparting a clamping force toward an opposing surface of the disc, the clamp contact surface extending radially from the central axis between in inner contact surface radius (such as 148) and an outer contact surface radius (such as 150), wherein the flange contact surface and the clamp contact surface are substantially equivalent and radially offset.

In one embodiment at least one of the contact surfaces comprises an arcuate surface (such as 140) acting along a substantially common radial distance from the central axis. Alternatively, at least one of the contact surfaces comprises an annular surface acting along a substantially common radial distance from the central axis.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the disc drive assembly while maintaining substantially the same functionality without departing from the scope and spirit of the present invention. In addition, although the preferred embodiment described herein is directed to a clamp assembly for a magnetic disc drive data storage system, it will be appreciated by those skilled in the art that the teachings of the present invention can be applied to other systems, like an optical data storage system, without departing from the scope and spirit of the present invention.

What is claimed is:

1. A data disc support assembly for supporting a data disc spinning around a central axis relative to a head disposed in a data reading and writing relationship with the disc, the data disc support assembly comprising:
a hub comprising first and second axial ends and a flange depending from the second axial end, the flange comprising a contact surface extending radially from the central axis between an inner contact surface radius and an outer contact surface radius and imparting a clamping force toward one surface of the disc; and
a clamp connected to the hub and comprising a contact surface imparting a clamping force toward an opposing surface of the disc, the clamp contact surface extending radially from the central axis between in inner contact surface radius and an outer contact surface radius, wherein the flange contact surface and the clamp contact surface are substantially equivalent and radially offset.

2. The data disc support assembly of claim 1 wherein at least one of the contact surfaces comprises an arcuate surface acting along a substantially common radial distance from the central axis.

3. The data disc support assembly of claim 1 wherein at least one of the contact surfaces comprises an annular surface acting along a substantially common radial distance from the central axis.

4. The data disc support assembly of claim 1 wherein the contact surfaces are offset such that the clamp contact surface acts along a radial distance relative to the central axis that is greater than that of the flange contact surface.

5. A disc drive comprising:
an enclosure;
a motor supported by the enclosure;
a data disc support assembly connected to the motor and spinning, in turn, a data disc in fixed rotation with the motor, the data disc support assembly comprising:
a hub comprising first and second axial ends and a flange depending from the second axial end, the flange comprising a contact surface extending radially from the central axis between an inner contact surface radius and an outer contact surface radius and imparting a clamping force toward one surface of the disc; and
a clamp connected to the hub and comprising a contact surface imparting a clamping force toward an opposing surface of the disc, the clamp contact surface extending radially from the central axis between an inner contact surface radius and an outer contact surface radius, wherein the flange contact surface and the clamp contact surface are substantially equivalent and radially offset.

6. The data disc support assembly of claim 5 wherein at least one of the contact surfaces comprises an arcuate surface acting along a substantially common radial distance from the central axis.

7. The data disc support assembly of claim 5 wherein at least one of the contact surfaces comprises an annular surface acting along a substantially common radial distance from the central axis.

8. The data disc support assembly of claim 5 wherein the contact surfaces are offset such that the clamp contact surface acts along a radial distance relative to the central axis that is greater than the flange contact surface.

9. A disc drive comprising:
a motor spinning a data disc in a data reading and writing relationship with a read/write head; and
connecting means for connecting the data disc to the motor by offsetting opposing axial forces to reduce disc deformation.

10. The disc drive of claim 9 wherein the motor comprises a spinable hub having a first axial end and a second axial end, the second axial end comprising a flange contact surface defining the radial plane at which clamping axial force is imparted to the data disc in attaching the data disc in a fixed rotation with the motor.

11. The disc drive of claim 10 wherein the first axial end of the hub supports a clamp, the clamp comprising a contact surface defining the radial plane at which clamping axial force is imparted to the data disc in attaching the data disc in a fixed rotation with the motor.

12. The disc drive of claim 11 wherein the flange contact surface radial plane is substantially different than the clamp contact surface radial plane providing the offsetting opposing axial forces.

13. The disc drive of claim 12 wherein the contact surfaces extend radially from the central axis substantially an equivalent length.
